(19) United States
(12) Patent Application Publication
(10) Pub. No.: US 2026/0184940 A1
(43) Pub. Date: Jul. 2, 2026

(54) INTUMESCENT COATING COMPOSITION

(71) Applicant: PPG Coatings (Kunshan) Co., Ltd., Suzhou,Jiangsu (CN)

(72) Inventors: Hao Wu, Kunshan (CN); Haoran Zhang, Suzhou (CN); Luoyi Zhu, Shanghai (CN); Shaohua Ma, Shanghai (CN)

(73) Assignee: PPG Coatings (Kunshan) Co., Ltd., Suzhou,Jiangsu (CN)

(21) Appl. No.: 19/125,169

(22) PCT Filed: Oct. 26, 2023
(86) PCT No.: PCT/CN2023/126814

§ 371 Date: Apr. 28, 2025

(30) Foreign Application Priority Data
Nov. 7, 2022 (CN) 202211383916.0

(51) Int. Cl. C09D 5/18; C09D 7/63; C09D 163/00

(52) U.S. Cl. CPC C09D 5/185; C09D 7/63; C09D 163/00

(57) ABSTRACT

The present application relates to an intumescent coating composition including: (a) an epoxy resin including in the backbone one or more alkylene moieties all of which are selected from a di-valent alkane radical of formula (I) in which Ra and Rb are each H, OH or an aromatic group and z is an integer of 1 to 8, and/or a di-valent cyclic alkane radical, (b) an alkylene bis(meth)acrylate, wherein said alkylene has 4 or more, preferably 5 or more, carbon atoms, (c) a curing agent, and (d) a compound providing an expanding gas upon thermal decomposition. Additionally, the present application further relates to a method of coating a substrate and a substrate at least partially coated with a coat deposited from the coating composition.

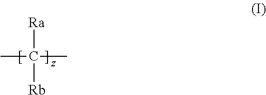

### TECHNICAL FIELD

The present disclosure relates to an intumescent coating composition, in particular an intumescent coating composition comprising epoxy resins.

### BACKGROUND ART

Many materials such as steel rapidly lose their strength and fail in a fire. Structural collapse of “high-rise” office blocks, oil and gas facilities, or other infrastructure, and process vessel or pipework rupture as a result of a fire can be catastrophic in terms of escalation of the incident, damage to property, and even loss of life.

Intumescent coatings are used on many structures to delay the effects of a fire. These structures include profiled, cold rolled steel, concrete, wood, aluminum, mixed metals, plastic substrates, and batteries. Intumescent coatings generally contain some form of resinous binder, for example a high-temperature polymer such as an epoxy resin and an appropriate crosslinker. The resinous binder forms the hard coating. If an epoxy resin is present in the binder, the binder also provides a source of carbon, which, in a fire, is converted to a char.

Epoxy resins formed based on bisphenol A, also known as BPA, for example the bisphenol A-type epoxy resins formed by condensing bisphenol A and epichlorohydrin under basic conditions, are used as resinous binders of coatings in some intumescent coating solutions in the art. It has been found, however, that it is difficult to further improve the fire resistance of the BPA-type epoxy resins, and the intumescent coatings based on such epoxy resins are often apt to sag in a fire.

It is therefore an object of the present disclosure to provide an intumescent coating composition for fire protection, which should exhibit improved fire resistance and mechanical properties than intumescent coating compositions based on bisphenol A epoxy resins.

### SUMMARY

These objects and other objects can be achieved by an intumescent coating composition comprising:
(a) an epoxy resin including in the backbone one or more alkylene moieties all of which are selected from a di-valent alkane radical of formula

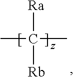

in which Ra and Rb are each H, OH or an aromatic group and z is an integer of 1 to 18, such as 1 to 8, and/or a di-valent cyclic alkane radical,
(b) an alkylene bis(meth)acrylate, wherein the alkylene moiety has 4 or more, preferably 5 or more, carbon atoms,
(c) a curing agent, and
(d) a compound providing an expanding gas upon thermal decomposition; wherein the compounds (a) to (d) are different from each other.

The present disclosure further relates to a method of coating a substrate including applying to the substrate the intumescent coating composition according to the present disclosure.

Additionally, the present disclosure also relates to a substrate at least partially coated with a coat deposited by the intumescent coating composition according to the present disclosure.

It has been found that the intumescent coating composition according to the present disclosure, as compared to those comprising other structures, in particular epoxy resins having a branched alkylene moiety with aliphatic side chains, e.g., bisphenol A-type epoxy resins, has improved char-forming and anti-sagging properties. At the same time, the intumescent coating composition according to the present disclosure has a lower viscosity, and thus a solvent-free system formulated with such a composition may be more suitable for spraying and better atomized so that the paint films formed by spraying said composition have improved appearances. Moreover, the intumescent coating composition according to the present disclosure, as compared to intumescent coating compositions based on epoxy resins having a branched alkylene moiety with aliphatic side chain in the backbone, e.g., bisphenol A-type epoxy resins, may further have improved flexibility.

### DETAILED DESCRIPTION

The intumescent coating composition according to the disclosure comprises:
(a) an epoxy resin including in the backbone one or more alkylene moieties all of which are selected from a di-valent alkane radical of formula

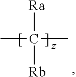

in which Ra and Rb are each H, OH or an aromatic group and z is an integer of 1 to 18, such as 1 to 8, and/or a di-valent cyclic alkane radical,
(b) an alkylene bis(meth)acrylate, wherein said alkylene has 4 or more, preferably 5 or more, carbon atoms,
(c) a curing agent, and
(d) a compound providing an expanding gas upon thermal decomposition.

As known for a person skilled in the art, the so-called “epoxy resin” refers to an epoxy resin or a polyepoxy compound having, on average, more than one, preferably two or three or more, epoxy groups, which may be a liquid epoxy resin or a solid epoxy resin.

Example epoxy resins include polyglycidyl ethers derived from polyols such as ethylene glycol, diethylene glycol, triethylene glycol, bisphenol A, hydrogenated bisphenol A, bisphenol F, hydrogenated bisphenol F, or polyether glycols such as polytetrahydrofuran glycol, polyethylene glycol, or polypropylene glycol.

Additionally, the epoxy resin may further include polyglycidyl ethers of polycarboxylic acids, which are formed by reacting an epoxy compound such as epichlorohydrin with an aliphatic or aromatic polycarboxylic acid such as oxalic acid, succinic acid, glutaric acid, terephthalic acid, 2,6-naphthalenedicarboxylic acid, or dimerized linoleic acid.

Other examples of the epoxy resin may include epoxidized ethylenically unsaturated alicyclic materials such as epoxy alicyclic ethers and esters, epoxy resins containing oxyalkylene groups, or epoxy novolac resins, which are prepared by reacting epihalohydrin with a condensation product of aldehydes and monohydric or polyhydric phenol (such as epoxy phenol novolac resins or epoxy cresol novolac resins).

In the intumescent coating composition, flexible polyepoxy resins such as epoxidized soybean oil, dimerized acid-based materials, and rubber-modified polyepoxy resins such as a product prepared from a polyglycidyl ether of bisphenol A and an acid-functional polybutadiene.

Other commonly used polyepoxides may further include, for example, epoxy-functional adducts prepared with flexible acid-functional polyesters and polyepoxides, and epoxy-functional acrylic resins.

The intumescent coating composition according to the present disclosure can be based on epoxy resins, meaning that a binder of the coating may be substantially composed of an epoxy resin, e.g. at least 90 wt. %, at least 95 wt. %, at least 98 wt. % or at least 99 wt. %, or all of the binder being composed of the epoxy resin, based on the total weight of the binder of the coating.

However, as above described, the intumescent coating composition according to the present disclosure may comprise an epoxy resin including in the backbone one or more alkylene moieties all of which are defined as above. Advantageously, the epoxy resin having in the backbone one or more alkylene moieties makes up a predominant part of the epoxy resin binder in the intumescent coating composition of the present disclosure. For example, based on the total weight of the epoxy resin binder, at least 90 wt. %, at least 95 wt. %, at least 98 wt. %, or at least 99 wt. %, or all of the epoxy resin may be comprised of the epoxy resin having in the backbone one or more alkylene moieties.

In the context of the present application, the “backbone” of the epoxy resin refers to a moiety of the epoxy resin after removing all epoxy groups, e.g., epoxy group (oxirane group) or epoxypropoxy group, which may be a substituted or unsubstituted divalent or polyvalent hydrocarbonyl group optionally having an ether oxygen atom.

The epoxy resin according to the disclosure has one or more alkylene moieties in the backbone, with the proviso that all alkylene moieties are selected from a di-valent alkane radical of formula

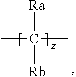

in which Ra and Rb are each H, OH or an aromatic group and z is an integer of 1 to 18, such as 1 to12 or 1 to 8, e.g., 1, 2 or 3, or from a divalent cyclic alkane radical. In another word, all the alkylene moieties in the backbone of the epoxy resin according to the disclosure should be linear or branched alkylene groups only substituted with OH or aromatic gropus, or cyclic alkylene groups. Hence, according to this definition, the backbone of the epoxy resin (a) according to the disclosure should not contain other forms of the akylene groups such as an alkylene moiety having alphatic side chains, e.g.,

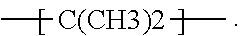

The “alkylene group” denotes an alkane radical in a divalent form, and the “alkylene moiety” can be considered as a moiety or segment including alkylene groups, which have two linkages at both ends, to bond non-alkylene moieties of different natures, such as ether oxygen, glycidyl, or aromatic groups (e.g., phenyl).

The “alkyl group” or “alkylene group” is derived from alkanes, compounds formed by linking all the carbon atoms in the molecule with single carbon-carbon bonds and binding hydrogens with the remaining valences of carbon atoms. The alkanes may have, for example, from 1 to 30, such as from 2 to 20 or from 3 to 18 or from 4 to 12, carbon atoms. In general, the alkanes may have a straight chain (linear), branched, or cyclic structure. The branched alkanes may be also considered as the forms obtained by substituting linear alkanes by alkyl groups. The cyclic alkanes may have at least 3 such as 4, 5, or 6, carbon atoms, and they may have 1, 2, 3, or more rings. Examples of the alkanes include methane, ethane, propane, cyclopropane, butane, cyclobutane, pentane, cyclopentane, hexane, cyclohexane, heptane, or the like. In the present application, the alkanes may further include halogen (e.g., F, Cl, or Br) substituted forms thereof.

In the context of the present disclosure, the “aryl group” or “aromatic group” denotes a group formed by removing one or more hydrogen atoms on an aromatic core carbon in an aromatic hydrocarbon (arene) of a ring structure. The arene typically has more than 5 carbon atoms such as 6 to 30 or 7 to 20 carbon atoms. Examples of the aryl group include phenyl, methylphenyl, ethylphenyl, biphenyl or the like. In the present application, the arene may include alkyl or halogen (e.g., F, Cl, or Br) substituted forms thereof.

The alkylene moiety may be a divalent alkane radical of formula

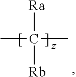

in which Ra and Rb are each H or phenyl, preferably H, and z is an integer from 1 to 6, preferably from 1 to 4. Advantageously, the alkylene moiety comprises a methylene radical (—CH₂—) bridging two aromatic groups such as phenyl at both ends.

The epoxy resin may have in the backbone one or more alkylene moieties that may have the formula X-(G)n, wherein G denotes a glycidyl group, X denotes an n-valent hydrocarbon group comprising or consisting of one or more said alkylene moieties, optionally one or more ether-oxygen atoms and optionally one or more aromatic groups, and n denotes an integer greater than or equal to 2, for example 2-30, 3-20, 3-10 or 2-6 or preferably 2, 3 or 4. X may be considered as the backbone of the epoxy resin.

The backbone X may comprise alkylene moieties, (poly)oxyalkylene groups composed of the alkylene moieties and one or more ether oxygen atoms, or structural units composed of the alkylene moieties (especially a divalent alkane radical of formula

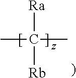

and the aromatic groups (such as phenyl or methylphenyl) linked at both ends thereof, or mixtures thereof; or the backbone X is composed of them.

Examples of suitable epoxy resins of formula X-(G)n include a polyglycidyl ether derived from polyol including alkane polyol, for example, ethylene glycol, diethylene glycol, triethylene glycol, 1,2-propanediol, 1,4-butanediol, 1,5-pentanediol, 1,6-hexanediol, 1,2,6-hexanetriol, cyclohexanedimethanol, glycerol, trihydroxymethyl propane, bisphenol F, hydrogenated bisphenol F or polyether glycol, and further epoxy phenol novolac resins or epoxy cresol novolac resins; preferably, bisphenol F-type epoxy resins, epoxy phenol novolac resins, epoxy cresol novolac resins, 1,6-hexanediol diglycidyl ether, and 1,4-butanediol diglycidyl ether; more preferably, bisphenol F-type epoxy resins, epoxy phenol novolac resins, or epoxy cresol novolac resins.

Bisphenol F-based epoxy resins (also known as bisphenol F-type epoxy resins or diglycidyl ethers of bisphenol F, abbreviated as “BPF”) may be produced by reacting bisphenol and formaldehyde in the presence of an acidic catalyst to produce bisphenol F which is further brought to a condensation reaction with epichlorohydrin under basic conditions.

Particularly, the bisphenol F-based epoxy resin may have a structure of formula (I):

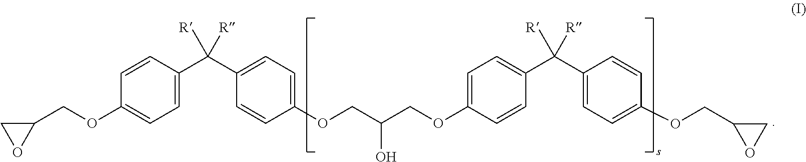

Here, the substituents R′ and R″ each are independently H.

In case of a solid epoxy resin, the index s has a value >1.5, especially 2-12. A compound of formula (II) having the index s of 1-1.5 is a semi-solid epoxy resin. In case of a liquid epoxy resin, the index s has a value of less than 1.

Suitable bisphenol F-based epoxy resins in the present disclosure may be commercially available, for example, KUKDO YDF-170, available from Kukdo chemical.

A phenolic epoxy resin may be also used, including so-called epoxy phenol novolac resin or epoxy cresol novolac resin. These resins especially have the following formulae:

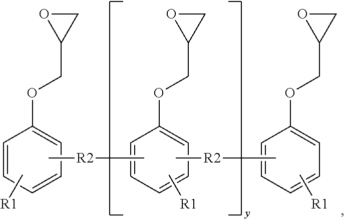

where R2=

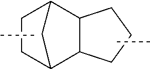

or CH₂, R1=H or methyl and y=0 to 7.

More particularly, these resins are epoxy phenol or cresol novolac resins (R2=CH₂).

These epoxy resins are also commercially available, for example Epikote 170, available from Momentive specialty chemicals.

The epoxy resin having in the backbone one or more alkylene moieties may be bisphenol F-based epoxy resins, phenolic epoxy resin or a mixture of both. It has been found that when the intumescent coating compositions comprise these epoxy resins, they can achieve improved fire resistance and mechanical properties as compared to the compositions based on bisphenol A epoxy resins.

The amount of the epoxy resin having in the backbone one or more alkylene moieties is in a range of 8 to 40 wt. %, preferably 12 to 30 wt. %, based on the total weight of the coating composition.

The intumescent coating composition according to the present disclosure may not contain a bisphenol A-type epoxy resin.

The intumescent coating composition according to the present disclosure may further comprise the component (b) alkylene bis(meth)acrylate, wherein said alkylene has 4 or more, preferably 5 or more, carbon atoms.

Particularly, the alkylene bis(meth)acrylate may be represented by R(A)₂, wherein R denotes an alkylene group having 4 or more, such as 5 or more, such as 6-12 or 6-10 carbon atoms, and A denotes a (meth)acrylate group.

In the alkylene bis(meth)acrylate, the alkylene group is preferably linear. The alkylene bis(meth)acrylate may not have a hydroxyl-substituted functional group.

Suitable alkylene bis(meth)acrylates for use in the disclosed compositions include, for pentanediol example, bis(meth)acrylate, hexanediol bis(meth)acrylate, heptanediol bis(meth)acrylate, octanediol bis(meth)acrylate, nonanediol bis(meth)acrylate, decanediol bis(meth)acrylate, dodecanediol bis(meth)acrylate, preferably hexanediol bis(meth)acrylate.

Such alkylene bis(meth)acrylates are known or they can be prepared by known methods. For example, a suitable proportion of (meth)acrylic acid may be selected to react with a diol on which the corresponding R radical is based to produce desired alkylene bis(meth)acrylates. They may be also commercially available, for example ALLNEX HDDA, which is available from Allnex.

In the disclosed intumescent coating composition, the amount of the component (b) alkylene bis(meth)acrylate, is in the range of 5 to 20 wt %, preferably from 7 to 15 wt %, based on the total weight of the coating composition. It has been found that the alkylene bis(meth)acrylate not only may reduce the viscosity of solvent-free coatings, but also can better incorporate into an epoxy/amine curing system, whilst providing improved flexibility to the curing system. It has been furthermore found that epoxy resin systems that include alkylene bis(meth)acrylate may result in improved thermal stability at high temperatures and make paint films having a relatively high melt viscosity, thereby avoiding the high temperature sagging.

The intumescent coating composition according to the disclosure may further include a curing agent (c) bearing a plurality of functional groups reactive with the epoxy group of the epoxy resin and the (meth)acrylate group of the component (b). Curing can take place either at ambient temperature or upon application of heat. The curing agent (c) may be selected from polyamine-functional compounds, polythiol compounds, and combinations thereof.

The polyamine curing agent may be selected from aliphatic polyamines, aromatic polyamines, polyamides, polyetheramines, for example those commercially available from Huntsman Cooperation, The Woodlands, Texas, polysiloxane amines, polysulfide amines or combinations thereof. Examples include diethylene triamine, 3,3-amino-bis-propylamine, triethylene tetraamine, tetraethylene pentaamine, cyclohexyldimethylamine (1,2-BAC), m-xylylenediamine (MXDA), and the reaction product of a polyamine and an aliphatic fatty acid such as the series of materials sold by BASF under the trademark VERSAMID can be used.

The polythiol compounds may be selected from polysulfide thiols, polyether thiols, polyester thiols, pentaerythritol based thiols; or combinations thereof. An example polythiol for use in the intumescent coating composition includes Thioplast© G4 commercially available from Akzo Nobel Functional Chemicals GmbH&Co KG, Greiz, Germany.

In the intumescent coating composition, the equivalent ratio of combined epoxy group and (meth)acrylate groups to functional groups in the component (c) may be from 2:1 to 1:2.

The intumescent coating composition may further comprise, as component (d), a compound providing an expansion gas upon thermal decomposition.

The expansion gas serves to cause the fire-protective intumescent composition to foam and swell when exposed to the high temperature of flames. As a result of this expansion the char which is formed is a thick, multicelled material that serves to insulate and protect the underlying substrate. The source of expansion gas that may be used in the intumescent coating composition of the present disclosure is a nitrogen-containing material. Examples of suitable nitrogen-containing materials include melamine, salts of phosphoric acid, guanidine, methylolated melamine, hexamethoxymethyl melamine, urea, dimethylurea, melamine pyrophosphate, dicyandiamide, guanylurea phosphate and glycine. Suitably, melamine is used. Other conventional sources of expansion gas can also be used such as those materials which liberate carbon dioxide. Examples are alkaline earth metals such as calcium carbonate or magnesium carbonate. Compounds which release water vapor as they decompose upon heating, for example calcium hydroxide, magnesium dihydroxide or aluminum trihydroxide, may also be used. Other examples of such compounds are boric acid and boric acid derivatives.

The amount of component (d) in the intumescent coating composition of the present disclosure may range from 0.1 to 25 wt.-%, suitably 1 to 10 wt.-%, whereby the weight percentage is based on the total solids weight of the composition.

The intumescent coating composition of the present disclosure may comprise optional additives (f) that are selected from a phosphorous source, a boron source, a zinc source, an acid source, a carbon source, inorganic fillers, mineral fibers (for example CHOPVANTAGE, commercially available from PPG), Coatforce or Roxul fibers (commercially available from Lapinus), rheology additives, organic solvents, pigments, foam stabilizers, and combinations thereof.

Furthermore, the intumescent coating composition of the present disclosure may comprise epoxy amine cure catalysts for example Ancamine® K54 commercially available from Evonik Industries, Marl, Germany or styrenated phenols such as Kumanox 3110F, commercially available from KUMHO PETROCHEMICAL. The amount of curing catalyst in the coating composition may range from 0.1 to 7 wt.-%, more suitably 1 to 5 wt.-% based on the total weight of the composition.

The source of phosphorous can be selected from a variety of materials, such as, for example, phosphoric acid, mono- and diammonium phosphate, tris-(2-chloroethyl)phosphate, phosphorus-containing amides such as phosphorylamide, and melamine pyrophosphate. Suitably, the source of phosphorous is an ammonium polyphosphate represented by the formula (NH₄)ₙ₊₂ PₙO₃ₙ₊₁, wherein n is an integer of at least 2, suitably n is an integer of at least 50. The intumescent coating composition of the present disclosure may contain an amount of phosphorous in the range of 0 to 20 wt.-%, suitably 0.5 to 10 wt.-%, based on the total solid weight of the coating composition. The phosphorous is believed to function as a char promoter in the intumescent composition.

The optional source of zinc can be selected from a variety of materials. It is believed that the zinc material contributes to the formation of a small-celled structure in the char. The small cells of the char afford improved insulation of the substrate and retain the char's integrity and adhere to the substrate even in the absence of external reinforcing materials. Thus, cracking of the char and its breaking away from the substrate are minimized and improved protection is afforded to the underlying steel. Examples of suitable materials which are sources of zinc include zinc oxide, zinc salts, such as zinc borate and zinc phosphate, zinc carbonate, and zinc metal. Suitably, zinc borate is utilized. The intumescent coating composition of the present disclosure may contain an amount of zinc in the range from 0 to 25 wt.-%, suitably 0.5 to 12 wt.-%, based on the total solids weight of the composition.

The source of boron may be selected from ammonium pentaborate or zinc borate, boron oxide, borates such as sodium borate, potassium borate and ammonium borate, borate esters such as butyl borates or phenyl borates and combinations thereof. The intumescent coating composition of the present disclosure may contain an amount of boron in the range from 0 to 10 wt.-%, suitably 1 to 6 wt.-%, whereby the weight percentage is based on the total solids weight of the composition.

The acid source may be selected from ammonium phosphate, ammonium diphosphate, diammonium pentaborate, polyphosphate, diammonium phosphoric acid generating materials, boric acid, metal or organic borates and combinations thereof.

The carbon source may be selected from (i) polyhydroxy compounds such as pentaerythritol, dipentaerythritol, glycerol, oligomeric glycerol, xylitol, mannitol, and sorbitol and (ii) polymers such as polyamides, polycarbonates, polyurethanes, and combinations thereof.

The phosphorus, zinc, boron, and compound providing an expansion gas upon thermal decomposition can each be provided by a separate source material or, alternatively, a single material may be a source of more than one of the aforementioned additional components. For example, melamine pyrophosphate can provide a source of both phosphorus and expansion gas.

The optional reinforcing fillers may be chosen from among a large array of conventionally utilized materials, including fibrous reinforcements and platelet reinforcements, which are suitable over other fillers. Examples of fibrous reinforcements include glass fibers, ceramic fibers, e.g., aluminum oxide/silicon oxide, and graphite fibers. Platelet reinforcements include hammer-mill glass flakes, mica, and wollastonite. Other suitable fillers include metal oxides, titanium oxides, clay, talc, silica, diatomaceous earth, Lapinus® fibers (commercially available from Lapinus), and various pigments. The reinforcing filler is believed to assist in controlling expansion of the intumescent coating composition prior to and during char formation so that the resultant char is hard and uniform. When present, the reinforcing filler is usually present in the composition in an amount ranging from 1 to 50 wt.-%, based on the total solids weight of the intumescent coating composition.

The intumescent coating composition of the present disclosure may also contain a variety of conventional additives, such as rheology additives, organic solvents, foam stabilizers, pigments, flame spread control agents, and the like. These ingredients are optional and can be added in varying amounts.

The intumescent coating composition may be configured as a two-component system, with component (a) and other possible epoxy resins as well as component (b) alkylene bis(meth)acrylate in a first package (A) and the curing agent component (c) in a second package (B), whereby the compound providing an expansion gas upon thermal decomposition (d) and any of the additives (f), if present, are comprised in any combination in either package (A) or package (B) or in both, or are comprised in one or more further packages (C). The individual packages are mixed prior to use of the intumescent coating composition.

The intumescent coating composition may be in the form of a thick material such as a mastic. It is particularly suitable that the composition be solvent-free and spray-applied. In the present disclosure, the term “solvent-free” or “solvent-free coating” means that the amount of an organic solvent contained in the intumescent coating composition is not more than 1% by weight, preferably not more than 0.5% by weight, more preferably not more than 0.1% by weight, particularly not more than 0.05% by weight, or completely free of organic solvent, based on the entire coating composition.

The intumescent coating composition of the present disclosure can be applied to a variety of substrates, particularly steel substrates, and when subjected to extreme variations in temperature over a short period of time, do not exhibit cracking. The intumescent coating composition of the present disclosure has improved flexibility and is particularly suitable for the protection of steel structures in cellulosic and hydrocarbon fires. The intumescent coating composition may not include webs, which are usually fibrous webs that are applied to prevent cracking, e.g., webs of carbon fibers or glass fibers.

The following examples are intended to be illustrative of the disclosure and are not intended to be limiting.

### EXAMPLES

The present disclosure is further illustrated below according to the examples. It should be appreciated that the following examples are illustrative but not limitative.

Description of the raw materials

| Name | Description |
|---|---|
| BPF Epoxy | Bisphenol F epoxy resin, YDF-170 |
| Novolac Epoxy | Novolac, Epikote 170 |
| BPA Epoxy | Bisphenol A epoxy resin, YD-128 |
| HDDA | Hexanediol bisacrylate with a functionality of 2 |
| | and no branched chains, ALLNEX HDDA |
| TMPTA | Trihydroxypropane triacrylate with a functionality |
| | of 3 and containing branched chains |
| LA | Lauryl acrylate, mono-functional |
| Flame-retardation | Including a polyphosphate source, melamine, |
| component | titanium dioxide, reinforcing fillers and the like |
| Rheological aid | A mixture comprising polyamide wax, clay, and |
| | fumed silica |
| Curing agent | Polyamine curing agent |

### Preparation of Coating Compositions

Parts A and B were formulated for each sample according to the composition shown in the following Table 1. Part A comprised an epoxy resin component, a (meth)acrylate component such as HDDA, TMPTA or LA, and a flame retardation component, as listed in Table 1, while Part B comprised a curing agent and a rheological aid. At room temperature, the individual components were added one by one according to the order of liquid-solid-aid, and if necessary, they were dispersed by stirring, thereby preparing Part A and Part B. Subsequently, the two parts were mixed and sufficiently stirred so as to prepare a coating composition. According to different test requirements as described below, the coating composition was subjected to performance tests.

TABLE 1

| component | Samples | | | | | | | | |
|---|---|---|---|---|---|---|---|---|---|
| wt % | 1 | 2 | 3 | 4 | 5 | 6 | 7 | 8 | 9 |
| BPF Epoxy | 0% | 0% | 16.06% | 16.06% | 6.35% | 24.64% | 0% | 0% | 6.35% |
| Novolac | 0% | 16.06% | 0% | 0% | 9.71% | 0% | 24.64% | 0% | 9.71% |
| Epoxy | | | | | | | | | |
| BPA Epoxy | 16.06% | 0% | 0% | 0% | 0% | 0% | 0% | 24.64% | 0% |
| HDDA | 8.58% | 8.58% | 8.58% | 4.58% | 8.58% | 0% | 0% | 0% | 0% |
| TMPTA | 0% | 0% | 0% | 4.00% | 0% | 0% | 0% | 0% | 0% |
| LA | 0% | 0% | 0% | 0% | 0% | 0% | 0% | 0% | 8.58% |
| Flame | 59.63% | 59.63% | 59.63% | 59.63% | 59.63% | 59.63% | 59.63% | 59.63% | 59.63% |
| retardation | | | | | | | | | |
| component | | | | | | | | | |
| Rheological | 2.80% | 2.80% | 2.80% | 2.80% | 2.80% | 2.80% | 2.80% | 2.80% | 2.80% |
| aid | | | | | | | | | |
| Curing | 12.93% | 12.93% | 12.93% | 12.93% | 12.93% | 12.93% | 12.93% | 12.93% | 12.93% |
| agent | | | | | | | | | |

### Methods of Performance Tests

### 1. Burning Tests:

Parts A and B were uniformly mixed and then applied to an H-shaped steel to form a dry film with the thickness of 12 mm. The H-shaped steel was of the size according to the specifications in GB/T11263-2017 and of the model HW250×250×9×14. Thermocouples were mounted according to UL263 Standard. On each H-shaped steel, the thermocouples were mounted in 4 layers with each layer having 5 thermocouples mounted, for a total of 20 thermocouples. The terminal point of the burning test was judged according to UL 263. The coating was cured at the room temperature (23° C.) for 2 weeks and then subjected to the burning test. The test was a test with fire at 4 sides, and in the test the H-shaped steel was vertically placed in the middle of a furnace. The test results were recorded in Table 2.

TABLE 2
Burning test results: UL263 8FT hpa170 COLUMN, 12 mm DFT

| Sample number | Failure time | Charring |
|---|---|---|
| 1 | 99 minutes | Serious collapse |
| 2 | 194 minutes | No collapse |
| 3 | 182 minutes | No collapse |
| 4 | 116 minutes | Collapse |
| 5 | 188 minutes | No collapse |
| 6 | 165 minutes | No collapse |

As can be seen from the above table, the comparisons between Sample 1 and Samples 2-3 showed that use of a bisphenol F epoxy resin along with a phenolic epoxy resin can lead to improved fire resistant time, and this can avoid the sagging of a char layer and ensure the integrity of the char layer, thereby improving the fire resistant time as a whole. Furthermore, as also can be seen from Sample 4, when the amount of HDDA was below 5 wt. %, even if a considerable amount of TMPTA was added, it still resulted in the sagging of the char layer after a short time period.

### 2. Low-Temperature Anti-Cracking Test:

A T-shaped steel specimen with a length of 400 mm, a width of 120 mm, a height of 120 mm and a thickness of 3.5 mm was used. The surface of the T-shaped steel was sand blasted and coated with a zinc-rich epoxy primer (Sigma Zinc 109G, available from PPG). Then, the prepared intumescent coating samples 5, 6, 7, 8 and a comparative commercial product (SteelMaster 1200HPE, commercially available from Jotun) were applied onto the surface of individual T-shaped steel panels, respectively, to obtain a film thickness of 10 mm. Such prepared T-shaped steels were cured at room temperature for 24 hours and then cured at 60° C. for 4 hours. The specimens were then subjected to the following 20 freeze-thaw cycles: freezing in a refrigerator at −20° C. for 12 hours, then taking out of the refrigerator and immediately placing in an oven at 40° C. for 12 hours.

After each cycle was finished, the surface profile of each coated specimen was visually observed and the cycle number of each coated specimen prior to coat cracking and/or peeling off from a substrate was recorded, with the results being shown in the following Table 3. “Pass” meant that after 20 cycles, the painted films neither cracked nor peeled off from the substrates.

TABLE 3

| Sample number | Cycle number |
|---|---|
| 5 | 20 (pass) |
| 6 | 1 |
| 7 | 1 |
| 8 | 1 |

### 3. Adhesion Test

Adhesion tests were performed according to ASTM D4541. Coating Parts A and B were mixed uniformly and applied to a 300×300×5 mm iron plate which had been previously cleaned with solvents and treated by sand blasting. The dry film of the coat was controlled to a thickness of about 7 mm. After the iron plate was dried at room temperature for 7 days, it was subjected to a pull-off adhesion test. For each iron plate, three points were tested and averaged, and the results were reported in Table 4.

TABLE 4

| Sample number | Pull-off adhesion (MPa) |
|---|---|
| 5 | 9.8 |
| 9 | 3.4 |

10 As can be seen from Table 4, use of a mono-functional acrylate (lauryl acrylate (LA)), as compared to HDDA, resulted in reduced mechanical strength.

1. An intumescent coating composition comprising:
(a) an epoxy resin comprising in the backbone one or more alkylene moieties all of which are selected from a di-valent alkane radical of formula 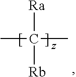
in which Ra and Rb are each H, OH or an aromatic group and z is an integer of 1 to 18, and/or a di-valent cyclic alkane radical,
(b) an alkylene bis(meth)acrylate, wherein the alkylene moiety has 4 or more carbon atoms,
(c) a curing agent, and
(d) a compound providing an expanding gas upon thermal decomposition.

2. An intumescent coating composition according to claim 1, wherein the alkylene moiety is a di-valent alkane radical of formula 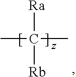
in which Ra and Rb are each H or phenyl, preferably H, and z is an integer of 1 to 6, preferably 1 to 4.

3. An intumescent coating composition according to claim 1, wherein the alkylene moiety comprises a methylene radical (—CH₂—) bridging two aromatic groups.

4. The coating composition according to claim 1, wherein the epoxy resin comprises a formula X-(G)n, wherein G denotes a glycidyl group, X denotes an n-valent hydrocarbon group comprising one or more said alkylene moieties, optionally one or more ether-oxygen atoms and optionally one or more aromatic groups, and n denotes an integer greater than or equal to 2.

5. The coating composition according to claim 4, wherein the epoxy resin of formula X-(G)n comprises a polyglycidyl ether derived from a polyol comprising an alkane polyol.

6. The coating composition according to claim 4, wherein the epoxy resin of formula X-(G)n comprises a bisphenol F epoxy resin, an epoxy phenol novolac resin, an epoxy cresol novolac resin, 1,6-hexanediol diglycidyl ether, 1,4-butanediol diglycidyl ether, or combinations thereof.

7. The coating composition according to claim 1, wherein at least 90 wt % of the epoxy resin, based on the total weight of the epoxy resin binder, comprises the epoxy resin including in the backbone one or more alkylene moieties.

8. The coating composition according to claim 1, wherein the alkylene-bis(meth)acrylate is represented by R(A)₂, wherein R denotes an alkylene group having 4 and A denotes a (meth)acrylate group.

9. The coating composition according to claim 1, wherein the alkylene-bis(meth)acrylate comprises pentanediol bis(meth)acrylate, hexanediol bis(meth)acrylate, heptanediol bis(meth)acrylate, octanediol bis(meth)acrylate, nonanediol bis(meth)acrylate, decanediol bis(meth)acrylate, dodecanediol bis(meth)acrylate, or mixtures thereof.

10. The coating composition according to claim 1, wherein the amount of component (b) alkylene di(meth)acrylate is in the range of 5-20 wt %, based on the total weight of the coating composition.

11. The coating composition according to claim 1, wherein the amount of said epoxy resin is in the range of 8-40 wt %, based on the total weight of the coating composition.

12. The coating composition according to claim 1, wherein the curing agent is selected from aliphatic polyamines, aromatic polyamines, polyamides, polyetheramines, polysiloxane amines, polysulfide amines or a combination thereof.

13. A method of coating a substrate comprising applying to the substrate the coating composition as claimed in claim 1.

14. A substrate at least partially coated with the coating composition as claimed in claim 1.
